(19) United States
(12) Patent Application Publication
(10) Pub. No.: US 2023/0023007 A1
(43) Pub. Date: Jan. 26, 2023

(54) PET PUZZLE TOY

(71) Applicant: PAW U SC LLC, Charleston, SC (US)

(72) Inventor: Sarah Beth Allison, Charleston, SC (US)

(21) Appl. No.: 17/871,540

(22) Filed: Jul. 22, 2022

Related U.S. Application Data
(60) Provisional application No. 63/224,582, filed on Jul. 22, 2021.

(51) Int. Cl. A01K 15/02

(52) U.S. Cl. CPC A01K 15/025

(57) ABSTRACT

A pet puzzle toy that holds toys or treats in an inner pocket and multiple outer pockets. The pet puzzle provides a challenge to the pet to attempt to retrieve the toys or treats from the pockets. Multiple sizes of the pet puzzle toy are nested to provide additional challenge for the pet.

### FIELD OF THE INVENTION

The present invention relates generally to pet toys. More specifically, the present invention relates to puzzle toys that contain treats.

### BACKGROUND OF THE INVENTION

When it comes to companionship with a pet, such as a dog or cat, it is always a joy to spend time playing with the pet. There are many different methods of having a fun and playful activity with a dog such as playing fetch, teaching, and treating the dog to learn tricks, tug-o-war with a rope-like toy, etc. Seemingly all activity and quality time with a dog requires accessories, toys, or other external items. Not many accessories, toys, or the like provide a puzzle for dogs to overcome and think. In addition, if the owner of a dog needs to distract their dog for a short period of time, there are not many available items that can do so.

An objective of the present invention is to provide a toy with which dogs are able to fiddle and play. The present invention provides a toy that rewards the dog with treats when interacted with correctly. Furthermore, the present invention provides a puzzling and playful toy to be used by dog owners.

### SUMMARY OF THE INVENTION

The present invention is a puzzle toy for pets. An inner pocket and a set of outer pockets hold toys or treats to entice the pet to play with the puzzle toy. The puzzle toy provides a challenge for the pet to retrieve the toys or treats. Multiple sizes of the puzzle toy can be nested to provide additional challenge for the pet.

### BRIEF DESCRIPTION OF THE DRAWINGS

FIG. 1 is a front view of Embodiment 1 of the present invention.

FIG. 2 is a top view of Embodiment 1 of the present invention.

FIG. 3 is a bottom view of Embodiment 1 of the present invention.

FIG. 4 is a front view of Embodiment 2 of the present invention.

### DETAILED DESCRIPTION OF THE INVENTION

All illustrations of the drawings are for the purpose of describing selected versions of the present invention and are not intended to limit the scope of the present invention.

The present invention provides a toy in which dogs are able to fiddle and play with the toy. The present invention provides a toy that rewards the dog with treats when interacted with correctly. Furthermore, the present invention provides a puzzling and playful toy to be used by dog owners. The present invention is a pouch that comprises a main pocket and a set of side pockets.

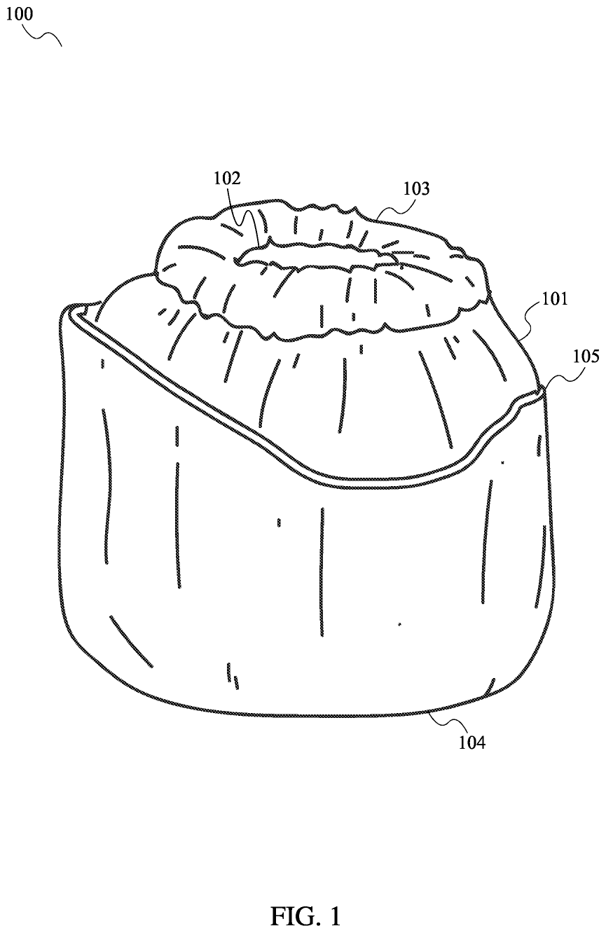

Referring to FIG. 1, Embodiment 1 comprises puzzle toy 100. Inner bag 101 is a cloth bag with opening 102 at the top. Cinch 103 contains an elastic band enclosed inside a cloth tunnel to hold opening 102 closed. Outer bag 104 is a cloth bag surrounding inner bag 101. For example, outer bag 104 may be made from canvas. Outer bag 104 has hem 105 to create a smooth edge. Outer bag 104 is attached to inner bag 101. In Embodiment 1, inner bag 101 and outer bag 104 are made from cloth. For example, inner bag 101 and outer bag 104 may be made from canvas. In alternate embodiments, inner bag 101 and outer bag 104 are made from other flexible materials.

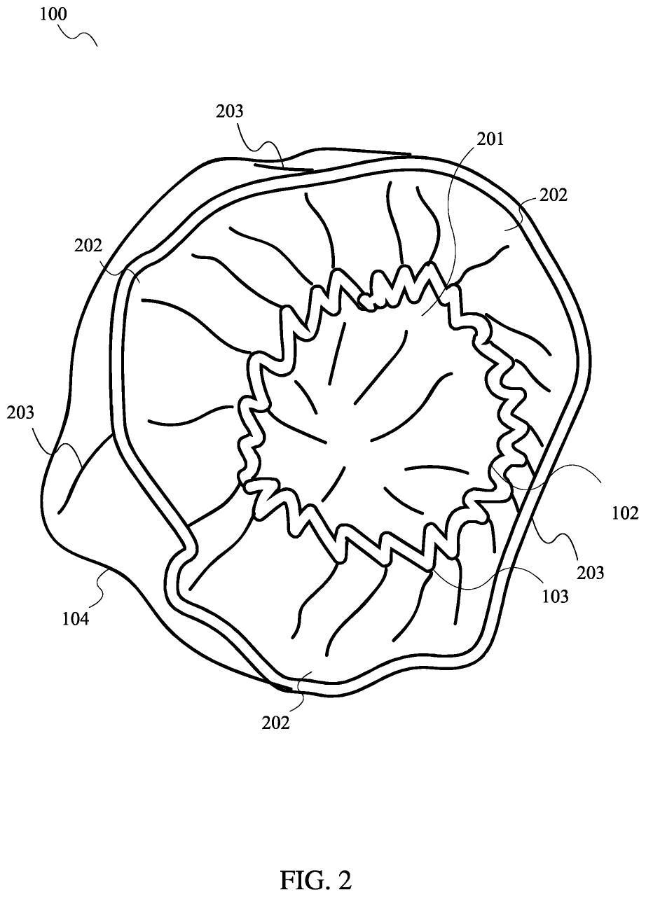

Referring to FIG. 2, Embodiment 1 comprises puzzle toy 100. Opening 102 provides access to main pocket 201. Main pocket 201 is used to hold a ball, toy, or treat during play. Cinch 103 is expanded to insert a toy or treat into main pocket 201. Side seams 203 connect outer bag 104 to inner bag 101, and side seams 203 divide the volume between inner bag 101 and outer bag 104 into multiple side pockets 202. In Embodiment 1, outer bag 104 is separated into three side pockets 202, which are evenly distributed. In alternate embodiments, outer bag 104 may have a single side pocket or may be separated into any number of side pockets, which may be spaced evenly or unevenly. Toys or treats are inserted into side pockets 202 to entice the pet to play with puzzle toy 100.

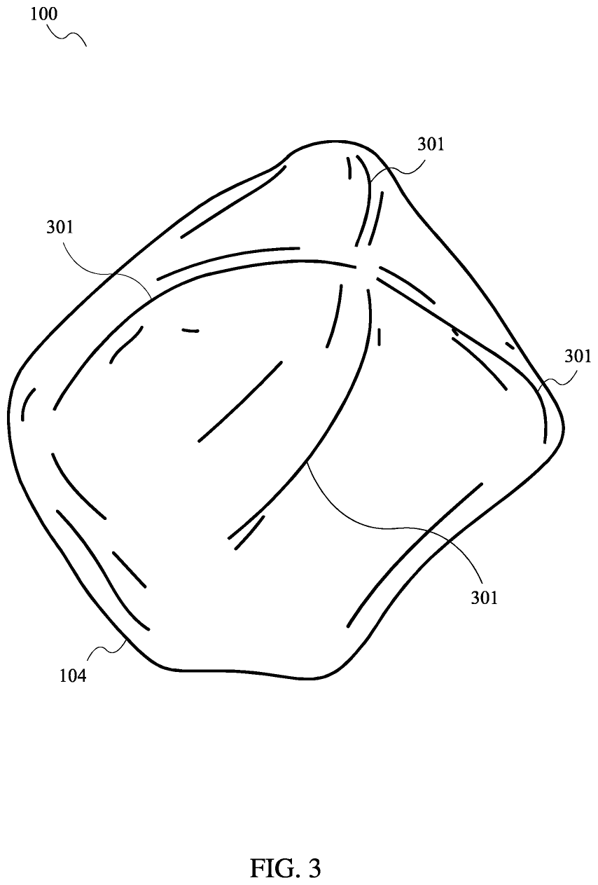

Referring to FIG. 3, Embodiment 1 comprises puzzle toy 100. Outer bag 104 has a closed bottom. The bottom of outer bag 104 is sewn shut with bottom seams 301. Bottom seams 301 increase the structure and durability of outer bag 104.

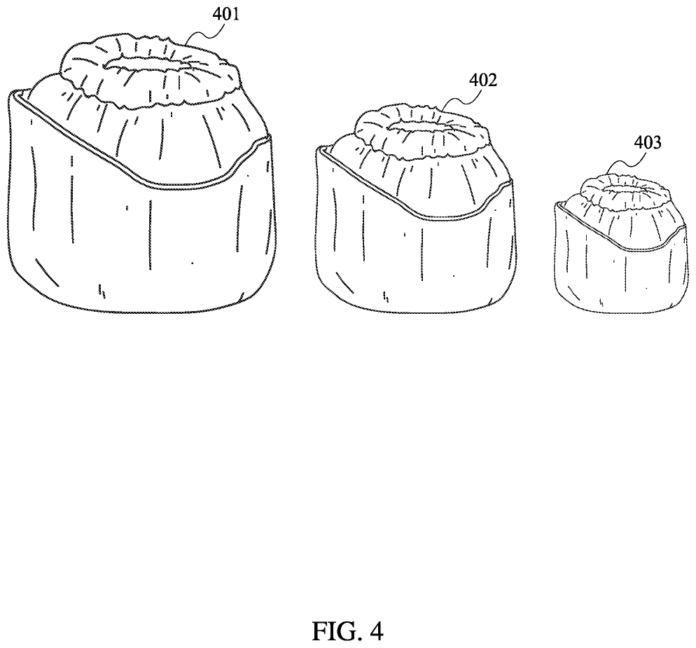

Referring to FIG. 4, Embodiment 2 comprises large puzzle toy 401, medium puzzle toy 402, and small puzzle toy 403. Embodiment 2 comprises three sizes of puzzle toys. Alternate embodiments may comprise any number of sizes of puzzle toys. Large puzzle toy 401, medium puzzle toy 402, and small puzzle toy 403 are constructed in the same manner as puzzle toy 100. A toy or treat is inserted into the main pocket of small puzzle toy 403. Additional toys or treats are inserted into the side pockets of small puzzle toy 403. Small puzzle toy 403 is inserted into the main pocket of medium puzzle toy 402. Additional toys or treats are inserted into the side pockets of medium puzzle toy 402. Medium puzzle toy is inserted into large puzzle toy 401, resulting in a nested set of puzzle toys. Additional toys or treats are inserted into the side pockets of large puzzle toy 403. The pet will first notice the toys or treats inside the side pockets of large puzzle toy 401. The pet will begin playing with large puzzle toy 401, attempting to retrieve the toys or treats from the side pockets. As the pet plays, it may notice medium puzzle toy 402 inside large puzzle toy 401 or smell the toys or treats inside the side pockets of medium puzzle toy 402. The pet is then enticed to remove medium puzzle toy 402 from the main pocket of large puzzle toy 401. Similarly, the pet notices small puzzle toy 403 inside the main pocket of medium puzzle toy 402, and the pet is enticed to remove small puzzle toy 403 from medium puzzle toy 402. The pet notices the toy or treat inside small puzzle toy 403, and the pet is enticed to remove the toy or treat from the main pocket of small puzzle toy 403.

Although the invention has been explained in relation to its preferred embodiment, it is to be understood that many other possible modifications and variations can be made without departing from the spirit and scope of the invention as hereinafter claimed.

What is claimed is:

1. A puzzle toy, comprising:
an inner bag, comprising a main pocket and an opening to the main pocket;
an outer bag surrounding the inner bag; and
one or more side seams defining one or more side pockets between the inner bag and the outer bag.

2. The puzzle toy of claim 1, wherein the one or more side seams connect the outer bag to the inner bag.

3. The puzzle toy of claim 2, wherein the one or more side seams separate the one or more side pockets.

4. The puzzle toy of claim 3, wherein the one or more side pocket have equal size.

5. The puzzle toy of claim 2, wherein a bottom surface of the outer bag is closed by one or more bottom seams.

6. The puzzle toy of claim 1, wherein the inner bag further comprises a cinch surrounding the opening.

7. The puzzle toy of claim 6, wherein the cinch further comprises an elastic band enclosed in an upper edge of the inner bag.

8. The puzzle toy of claim 1, wherein the outer bag further comprising a hem sewn into an upper edge of the outer bag.

9. The puzzle toy of claim 1, wherein:
the inner bag further comprises a first cloth material; and
the outer bag further comprises a second cloth material.

10. The puzzle toy of claim 9, wherein:
a. the first cloth material comprises canvas; and
b. the second cloth material comprises canvas.

11. A puzzle toy, comprising:
an inner bag comprising a main pocket and an opening to the main pocket;
an outer bag surrounding the inner bag;
one or more side seams connecting the inner bag to the outer bag; and
one or more side pockets between the inner bag and the outer bag, the one or more side pockets separated by the one or more side seams.

12. The puzzle toy of claim 11, wherein the inner bag further comprises a cinch surrounding the opening.

13. the puzzle toy of claim 12, wherein the cinch further comprises an elastic band enclosed in an upper edge of the inner bag.

14. The puzzle toy of claim 11, wherein the outer bag further comprises a hem sewn into an upper edge of the outer bag.

15. The puzzle toy of claim 11, wherein the one or more side pockets have equal size.

16. the puzzle toy of claim 11, wherein:
the inner bag further comprises a first canvas material;
the outer bag further comprises a second canvas material.

17. A puzzle toy, comprising:
an inner bag comprising a main pocket and a cinch surrounding an opening to the main pocket;
an outer bag surrounding the inner bag, the outer bag comprising a hem and one or more bottom seams;
one or more side seams connecting the inner bag to the outer bag; and
one or more side pockets between the inner bag and the outer bag, the one or more side pockets defined by one or more side seams.

18. The puzzle toy of claim 17, wherein the outer bag further comprises a hem sewn into an upper edge of the outer bag.

19. The puzzle toy of claim 17, wherein the one or more side pockets have equal size.

20. The puzzle toy of claim 17, wherein:
the inner bag further comprises a first canvas material; and
the outer bag further comprises a second canvas material.
